(19) United States
(12) Patent Application Publication
(10) Pub. No.: US 2019/0233664 A1
(43) Pub. Date: Aug. 1, 2019

(54) HAPTIC COATING

(71) Applicant: Matt Industries, Syracuse, NY (US)

(72) Inventor: Edward J. Killey, Syracuse, NY (US)

(73) Assignee: Matt Industries, Syracuse, NY (US)

(21) Appl. No.: 16/261,674

(22) Filed: Jan. 30, 2019

Related U.S. Application Data
(60) Provisional application No. 62/624,081, filed on Jan. 30, 2018.

(51) Int. Cl. C09D 7/40; C09D 133/00; C09D 7/61; B41M 5/00

(52) U.S. Cl. CPC C09D 7/70; B41M 5/0011; C09D 7/61; C09D 133/00

(57) ABSTRACT

A coating applied to substrates such as papers and films yields a haptic sensation of skin, leather, velvety fabric or soft elastomers. Commonly referred to as a ‘soft touch’ coating, it retains the desired haptic appeal after being over-printed by various imaging ink systems. Improved haptic sensations are provided by expandable microspheres that impart a surface topography that is measured in micron and sub-micron undulations that align with the texture of the human finger skin. Non-skid behavior arises from the surface topography having enough undulations of such fine frequency that air is evacuated between the coating and any substantially smooth surface that a strong attraction is caused by a temporary vacuum when the coating is pressed against smooth surfaces.

### CROSS-REFERENCE TO RELATED APPLICATIONS

The present application claims priority to U.S. Provisional App. No. 62/624,081, filed on Jan. 30, 2018.

### BACKGROUND OF THE INVENTION

### 1. Field of the Invention

The present invention relates to coated paper, fabric and film substrates used in the printing and, more particularly, to a haptic coating for use with printed articles to impart a soft touch to the printed articles.

### 2. Description of the Related Art

Soft touch coatings have been formulated and applied to various substrates to create a surface that has a unique and attractive feel to the user. The printing markets have recognized that this soft touch effect is highly desirable and numerous coatings have been used along with the use of over-laminating films that have a soft touch coating applied thereon. The need for over-laminating films or even post-print coating applications are required because the use of inks or toners in printing processes nullify the effect of a soft touch coated substrate. The inks or toners used to create printed images overlay or ‘smother’ the surface of the soft touch coating rendering it useless for haptic sensations.

### BRIEF SUMMARY OF THE INVENTION

The present invention is a coating applied to substrates, such as papers and films that, yields a haptic sensation of skin, leather, velvet fabric or soft elastomers. The coating retains the desired haptic appeal after being over-printed by various imaging ink systems, whether prior to expansion or during expansion depending on the printing process. Improved haptic sensations are provided by expandable microspheres that impart a surface topography that is measured in micron and sub-micron undulations that align with the texture of the human finger skin. Non-skid behavior arises from the surface topography having enough undulations of such fine frequency that air is evacuated between the coating and any substantially smooth surface that a strong attraction is caused by a temporary vacuum when the coating is pressed against smooth surfaces.

In a first embodiment, a haptic coating according to the present invention comprises a polymer, an inert filler in the polymer, and a plurality of expandable microspheres in the polymer that are capable of expanding from a first volume to a second volume that is larger than the first volume. The polymer may be an acrylic, a polyester, a urethane, or a polyvinyl acetate. The inert filler may be silicas, calcium carbonates, magnesium silicates, clays, colored pigments, or combinations thereof. The coating may be deposited on a substrate with the expandable microsphere expanded to the second volume. Ink may be printed on the haptic coating prior to, during, or after the microspheres have expanded.

In another embodiment, a method of forming a haptic surface begins with the step of forming a coating using a polymer, an inert filler in the polymer, and a plurality of expandable microspheres in the polymer that are capable of expanding from a first volume to a second volume that is larger than the first volume. Next, the coating is applied to a substrate to form a coated substrate. Next, the coated substrate is dried. The step of drying the coating may be performed at a temperature that does not cause the expandable microspheres to expand. The coated substrate may then be printed. The printed and coated substrate may then be heated so that the expandable microspheres expand from the first volume to the second volume. The step of printing on the coated substrate may also occur at a temperature such that the step of heating the coated substrate occurs simultaneously. The step of drying the coating may be performed at a temperature that causes the expandable microspheres to expand and then the coated substrate may be printed after the expandable microspheres have expanded.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a flowchart of a manufacturing method of a haptic coating and printed coated product according to the present invention.

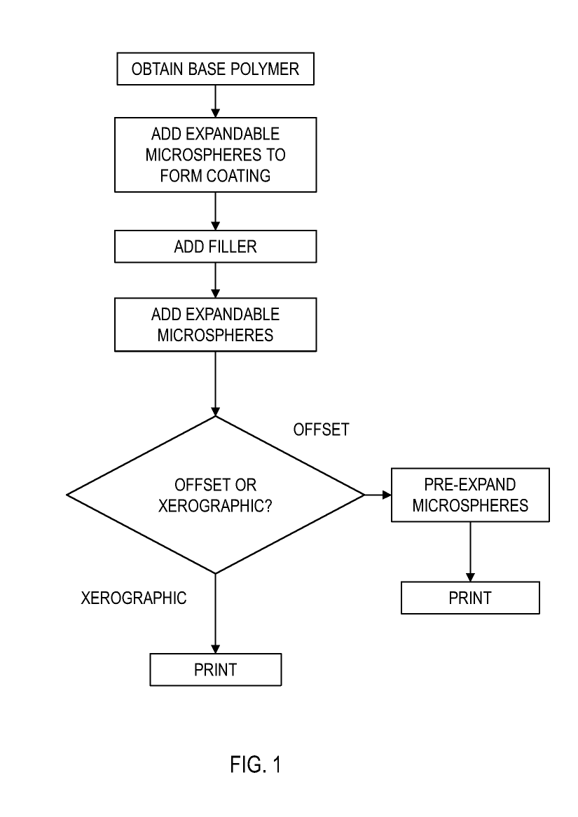

### DETAILED DESCRIPTION OF THE INVENTION

Referring to the figures, wherein like numeral refer to like parts throughout, the present invention comprises the use of polymers combined with inert fillers and expandable microspheres to create coatings that are applied in relatively thin layers to substrates such as papers and plastic films. The resultant coatings are then expanded by thermal induction either before or after printing through various print methods.

A base polymer acts as the carrier or binding component for the other ingredients that are needed for the finished coating. The polymer can be selected from acrylics, polyesters, urethanes, polyvinyl acetates and, in general, any polymeric material that is extensible under heat will find utility in the invention.

For the purposes of illustrating the invention, an acrylic resin will be used. Acrylic resins come in many derivations for numerous reasons such as water resistance, heat resistance, etc. In the present invention, Joncryl 624 from BASF Corporation was used as the binder resin. To the resin, expandable microspheres known as Expancel U31 D 40 from Akzo Nobel Corporation (thermoplastic microspheres encapsulating a gas that can expand to up to 6 times from original size without increasing in weight when heated) were added from 0.1 part to 90 parts based on 100 parts of Joncryl 624. An inert filler such as silica was added to aid in creating a dull or matte finish to the coating. The silica also provides an absorptive surface for inks. Silica from PPG known as LoVel 2023 was used for matting and surface absorptivity. Silica is added from 0.1 part to 90 parts to 100 parts of base resin. Other fillers such as calcium carbonates, magnesium silicates, clays or pigments for coloration can be added to achieve superficial effects without obstructing the haptic sensitivity of the base coating formula. The resulting coating also has non-skid properties.

The final coating is water-based and can be applied to substrates via many coating methods known in the industry such as gravure applicator, metering rod or slot die coating. The coating is applied in such a rate of deposition as to guarantee consistent overall coverage of the substrate. The water is evaporated through forced air drying but the heat applied to the substrate is kept at a minimum to keep the microspheres from pre-expanding based on the printing process the material is destined for.

In another process using the same coating, it is desirable to expand the microspheres during or after the drying process. After drying, the substrate is then sheeted and cut to a size that is required for the intended printing process.

There are two commonly used printing methods in the digital printing market. One is known as digital offset embodied by the HP Indigo print engines. The other printing system is xerographic or laser printing. The use of one or the other method determines whether the haptic coated sheet is pre-expanded or unexpanded.

For the Indigo engines, the coating is pre-expanded. The inks used by the Indigo are laid down extremely thin so that the inks are absorbed into the surface of the expanded haptic coating. The topography of the coating also disrupts the ink layer so that the human finger detects the topographic undulations of the coating and not the layer of disrupted ink.

In xerographic or laser printing as it is more commonly known, the heat of the fuser rollers is adequate to activate the microspheres into expansion and the haptic coating is completed with the toner particles becoming disrupted across the surface of the expanding coating. Due to the expansion during fusing, the toner particles cannot form a coherent skin layer that would nullify the effect of the haptic surface.

### Example 1

One part Expancel U31 microspheres was added to 5 parts water to pre-wet the particles. To the slurry, one part of Lovel 20203 silica was added. The resulting slurry was blended into 13 parts Joncryl 624 acrylic resin. The final coating was applied to a 14-point claycoated coverstock from WestRock Corporation. The coating was metered across the substrate with a #16 wire-wound rod. The coating was dried at 120° F. for five minutes to remove the water portion of the coating. The coverstock was printed in a Xerox iGen laser print engine.

### Example 2

One part Expancel U31 microspheres were added to 5 parts water to pre-wet the particles. To the slurry, one part of Lovel 20203 silica was added. The resulting slurry was blended into 13 parts Joncryl 624 acrylic resin. The final coating was applied to a 14-point claycoated coverstock from WestRock Corporation. The coating was metered across the substrate with a #16 wire-wound rod. The coating was dried at 120° F. for five minutes to remove the water portion of the coating. The coated coverstock was passed through a heated laminator set at 300° F. and 20 psi pressure between the heated rollers. The heat activated the coating causing expansion of the Expancel microspheres. The coating was then over coated with a solution of Michelman DigiPrime 5000 with a #6 wire wound rod. The DigiPrime acts as a primer for the inks that are used in HP Indigo digital engines.

### Example 3

One part Expancel U31 microspheres were added to 5 parts water to pre-wet the particles. To the slurry, one part of Lovel 20203 silica was added. The resulting slurry was blended into 13 parts Joncryl 624 acrylic resin. One-tenth of a part of Chanel No. 5 perfume was added to the coating. The final coating was applied to a 14-point claycoated coverstock from WestRock Corporation. The coating was metered across the substrate with a #16 wire-wound rod. The coating was dried at 120° F. for five minutes to remove the water portion of the coating. The coverstock was printed in a Xerox iGen laser print engine.

The printed products from the three examples all exhibited a soft suede-like feel across the printed surfaces. The purpose of adding the Chanel perfume was to produce a printed article that releases a desirable fragrance over an extended period. The expanded spheres occupy the entire upper surface and fragrance molecules are entombed in the underlying binder polymer but can diffuse slowly up and past the spherical structures above and into the surrounding atmosphere.

There are various grades of expandable microspheres and the main differences lie in particle sizes and temperature thresholds to cause expansion. Lower temperature activation is desirable for digital printing to take advantage of print speed and uniformly consistent expansion across large surfaces.

What is claimed is:

1. A haptic coating, comprising:
a polymer;
an inert filler in the polymer; and
a plurality of expandable microspheres in the polymer that are capable of expanding from a first volume to a second volume that is larger than the first volume.

2. The haptic coating of claim 1, wherein the polymer is an acrylic resin.

3. The haptic coating of claim 1, wherein the polymer is selected from the group consisting of an acrylic, a polyester, a urethane, and a polyvinyl acetate.

4. The haptic coating of claim 1, wherein the inert filler comprises silica.

5. The haptic coating of claim 1, wherein the inert filler is selected from the group consisting of silicas, calcium carbonates, magnesium silicates, clays, colored pigments, and combinations thereof.

6. The haptic coating of claim 1, further comprising a substrate on which the haptic coating has been applied.

7. The haptic coating of claim 6, wherein the expandable microspheres have expanded to the second volume.

8. The haptic coating of claim 7, further comprising ink printed on the haptic coating.

9. A method of forming a haptic surface, comprising the steps of:
forming a coating using a polymer, an inert filler in the polymer, and a plurality of expandable microspheres in the polymer that are capable of expanding from a first volume to a second volume that is larger than the first volume;
applying the coating to a substrate to form a coated substrate; and
drying the coated substrate.

10. The method of claim 9, wherein the step of drying the coating is performed at a temperature that does not cause the expandable microspheres to expand.

11. The method of claim 10, further comprising the step of printing on the coated substrate.

12. The method of claim 11, further comprising the step of heating the coated substrate so that the expandable microspheres expand from the first volume to the second volume.

13. The method of claim 12, wherein the step of printing on the coated substrate occurs at a temperature such that the step of heating the coated substrate occurs simultaneously.

14. The method of claim 9, wherein the step of drying the coating is performed at a temperature so that the step of heating the coated substrate occurs simultaneous and the expandable microspheres expand to the second volume.

15. The method of claim 14, further comprising the step of printing on the coating substrate after the expandable microspheres have expanded to the second volume.

16. The method of claim 9, further comprising the step of adding a fragrance component to the coating prior to applying the coating to the substrate.

17. The method of claim 9, wherein the coated substrate is selected from the group consisting of a paper, a fabric, and a film.
